(19) United States
(12) Patent Application Publication
(10) Pub. No.: US 2001/0014122 A1
(43) Pub. Date: Aug. 16, 2001

(54) Method and apparatus for video compression and restructuring

(76) Inventors: Hsin Chia Fu, Madison, WI (US); Chein Hsun Wang, Hsinchu City (TW); Yih Woei Liang, Hsin-Chu (TW)

Correspondence Address: Rosenberg, Klein & Bilker, 3444 Ellicott Center Drive-Suite 105, Ellicott City, MD, 21043, US

(21) Appl. No.: 09/765,357

(22) Filed: Jan. 22, 2001

Related U.S. Application Data
(62) Division of application No. 09/197,444, filed on Nov. 23, 1998.

(30) Foreign Application Priority Data
Sep. 15, 1998 (TW) 87115328

(51) Int. Cl. H04N 7/12

(52) U.S. Cl. 375/240.12; 375/240.26

(57) ABSTRACT

A method and apparatus for compressing and restructuring video signals are provided to promote the usefulness of a video channel, resulting in the efficacy of accommodating more video programs in a single video channel. Several video compressing and restructuring devices are used to directly compress multiple digital video data streams which are then integrated by a multiplexer. Each of the video compressing and restructuring devices comprises a plurality of video compressors for compressing the video codes of the digital video data stream, and a multiplexer for integrating the video codes having been compressed by the video compressor. Each video compressor comprises a trancoder for properly adjusting quantization scale for further compressing video signals. Based on the present invention, video signals are directly compressed with simple method and apparatus of low cost, leading to the realizing of an analogy Video-On-Demand system (approximate to a Video-On-Demand system).

### FIELD OF THE INVENTION

The present invention generally relates to a method and apparatus for video compression and reformatting, and particularly to a method and apparatus for enabling existing video channels to accommodate the transmission of more video programs.

### BACKGROUND OF THE INVENTION

It is getting more and more important to tackle the problem that the signal flow capacity and communication quality of a video transmission systems are always limited by channel bandwidth. This is because of the bulk of data contained in video signal and the higher communication quality required by video transmission. Although the number of video channels allowable for cable TV is more than 120, only very few remain available given that some are prohibited or are not suitable for using, resulting in extreme difficulty for acquiring channels for new video programs and new medium broadcast companies. Due to the limited number of channels available for application, the increase of number of the programs in a single channel shall be a good option for expanding the number of broadcast programs which, however, is limited by channel bandwidth, leading to a necessity of digital signal compression technology.

Shown in FIG. 1 is a conventional digital video signal transmission and receiving system in which 8 video programs are merged by multiplexing technology into a single video channel for transmission. As shown in FIG. 1, the system comprises a sending station 100 for sending processed video programs which are then transmitted through cable 200 to a receiving site to be received by STB (set-top-box) 300 thereat and delivered therefrom to users.

In sending station 100, a network management and control unit 110 is used to manage and control a subscriber management unit 112, a multiplex management unit 114, a conditional access unit 116, a multiplex and sever 118, and a 8:1 multiplexer 120; the input of 110 is connected to an electronic program guide 122 and a scheduler/trafficker 124 according to which a tape/archive 126 provides programs to be sent directly or through an encoder 128 to a multiplex and sever 118 which also receives a live video source 130 processed by a real-time encoder 132. Multiplex and sever 118 in turn sends a video signal to be processed by the 8:1 multiplexer 120 for merging into a single channel and then being processed by a modulator 140 in order to transmit through cable 200.

STB 300 receives, through a cable interface 302, from cable 200 a signal which has frequency reduced by a tuner 304 and is then demodulated by a demodulator 306 into a MPEG2 video signal consisting of 8 programs, and is demultiplexed afterwards by a 1:8 demultiplexer 308 into individual video signals for being applied to a bus 310 connecting a Direct Random Access Memory (DRAM) 312 and a flash memory 314 for saving data. Based on the system, the video programs selected by users are retrieved and saved in a DRAM 316 while the others are ignored. The signals contained in DRAM 316 are decoded by MPEG2 decoder 318, with digital video signals (digital video data stream) and digital audio signals individually inputted to a video digital-to-analog converter 320 and an audio digital-to-analog converter 322 to be respectively converted into analog video signals and analog audio signals for outputting to an ordinary TV for displaying. The 1:8 demultiplexer 308 also connects a infrared ray receiver (IR) 324 which is used by users to select a desired program through a remote controller.

Given that the bandwidth of a channel for current TV systems is about 6 Mhz with transmission speed at about 27 Mbps, and that a MPEG2 system is adopted, the digital signals will usually be provided (by most of MPEG2 Encoder, for example) with an average output speed of 3.3 Mbps. With 3.3 Mbps×8=26.4 Mbps<27 Mbps (equation 1), it can be seen at most 8 programs can be accommodated in a channel, e.g., only 8 programs can be broadcast simultaneously through one channel even though a MPEG2 system is used, thereby the number of increased programs is far beyond significant given that the number of available channels is so limited.

FIG. 2 shows a video signal obtained from MPEG2 compression, most of which are distributed in a small range of bandwidth, with scarce explosion 402 and swiftly moving rapid pan of high detail 404, implying feasible further compression.

FIG. 3(A) and FIG. 3(B) illustrate encoding and decoding algorithm of MPEG2. As can be seen in FIG. 3(A), a MPEG encoder comprises a discrete cosine transform unit 502, a quantizer 504, and a variable length encoder 506. Usually a video signal is converted through the three devices into a bit stream (digital video data stream) to be sent to user sites through a modulator and transmission medium. To reduce the bulk of signal flows,, many frames in MPEG2 system are transmitted on the basis of the difference between two successive frames, therefore a MPEG2 encoder further comprises a motion compensation unit 512 and a motion estimation unit. Due to the need that the two devices must operate with video signal data, a dequantizer 516 and an inverse discrete cosine transform unit 518 are further required. The final output is a MPEG2 bit stream (digital video data stream).

FIG. 3(B) illustrates the operation algorithm of a decoder, which reverses the operation shown in FIG. 3(A), i.e., the MPEG2 bit stream (digital video data stream) outputted by the encoder in FIG. 3(A) is inputted to the decoder in FIG. 3(B), and processed by a variable length decoder 522, a dequantizer 524, and an inverse discrete cosine transform unit 526, as well as a motion compensation unit 528, to eventually obtain a restored video signal as its output.

When proceeding quantization, the bulk of video data signal may be reduced by lowering quantization level. Although lowered quantization level naturally reduces quantized data signal, it leads to a drawback that the quality of video frames is lowered.

Paik suggested, in U.S. Pat. No. 5,216,503, a multi-channel video compression system using a statistical multiplexer to integrate multiple video programs in a conventional video channel. To avoid the unnecessary waste resulting from too big instant bandwidth of a single program, a buffer controller is used to generate, when the total bandwidth of these programs exceeds system capacity, a signal for requesting the quantizer to adjust quantization level so that the bandwidth is lowered.

When the aforementioned patent was filed, digital video signal standard had not been established, therefore its quantizer was designed for digitizing video signal (similar to MPEG). Nowadays some digital video signal standards such as ISO/IECJTCI/SC29/WG11 for MPEG2 have been established, thereby most of the video contents are processed according to these standards, resulting in a necessity of converting digital video contents into analog contents if the aforementioned patent is to be applied, leading to the need of extra decoding devices and extremely long operating time.

It can be seen now that a practicable method and apparatus for integrating multiple programs in a conventional video channel can be adopted only if it fits the existing video system and maintains the quality of video frames. The requirement, however, is beyond the capacity of conventional arts.

### SUMMARY OF THE INVENTION

An object of the present invention is to provide a method and apparatus for integrating multiple video programs in a video channel.

When bandwidth is extremely limited, digital video signal is further compressed according to the present invention under the condition that it is not to be sensed by the eyes of human being, leading to more efficient utilization of existing channels. It is therefore another object of the present invention to provide a method and apparatus for compressing and restructuring video signals.

Another further object of the present invention is to promote operation efficiency of a video system by enabling a single channel to accommodate more video programs.

The other further object of the present invention is to provide a method and apparatus for directly compressing video signals to realize a real time video system.

Furthermore, digital video signals (digital video data stream) can be directly compressed according to the present invention to enable a single channel to accommodate more video programs, therefore it is also an object of the present invention to provide a video compressor and a method for compressing digital video data, as well as a trancoder and associated method for compressing digital video data.

The trancoder suggested by the present invention is characterized in that a better quantization scale can be achieved by determining a new quantization scale when quantizing data. It is therefore also another object of the present invention to provide a neural network quantization scale predictor for determining an optimum quantization scale.

The compression of digital video signal suggested by the present invention is characterized in that the quantization level for the areas of a video frame which are less sensitive to human eyes is reduced while the quantization level for those which are sensitive to human eyes is maintained

In an embodiment of the present invention, multiple digital video compressing and restructuring devices (or called Q-mux) are used to directly compress digital video signals (digital video data stream) which are then integrated by a multiplexer; each digital video compressing and restructuring device has a multiplexer to restructure digital codes (digital codes of the multiple digital video signals) having been compressed by video compressors (or called Q-presser); each video compressor comprises at least a trancoder to reduce the quantization level for the areas of a frame which are less sensitive to human eyes, in order to further compress digital video signal.

The present invention may best be understood through the following description with reference to the accompanying drawings.

### BRIEF DESCRIPTION OF THE DRAWINGS

FIG. 1 shows a conventional video transmission and receiving system wherein 8 video programs are merged in a single channel.

FIG. 2 shows video signal bandwidth distribution of a conventional MPEG2.

FIG. 3 shows an encoder and decoder of MPEG2, among which FIG. 3(A) shows the encoder and FIG. 3(B) shows the decoder.

FIG. 4 illustrates, on the basis of video bandwidth distribution, the video compression algorithm suggested by the present invention.

FIG. 5 illustrates an embodiment of the present invention allowing up to 24 video programs to be accommodated in a single channel.

FIG. 6 illustrates an embodiment of a trancoder suggested by the present invention.

FIG. 7 illustrates an embodiment of a quantization scale predictor suggested by the present invention, which is achieved by a neural network of 3 layers.

FIG. 8 shows an embodiment of a video transmission and receiving system suggested by the present invention.

FIG. 9 shows an embodiment of a video-on-demand analogy system (approximate to a video-on-demand system) suggested by the present invention.

### Reference Numerals

100 sending station

110 network management and control unit

112 subscriber management unit 112

114 multiplex management unit

116 conditional access unit 116

118 multiplex and sever 118

120 8:1 multiplexer 120

122 electronic program guide 122

124 scheduler/trafficker 124

126 tape/archive 126

128 encoder

130 live video source 130

132 real-time encoder 132

140 modulator

200 cable

300 STB (SET-TOP-BOX)

302 cable interface

304 tuner 304

306 demodulator

308 demultiplexer

310 bus

312 Direct Random Access Memory (DRAM)

314 flash memory

316 DRAM

318 MPEG2 decoder

320 video digital-to-analog converter

322 audio digital-to-analog converter

324 infrared ray receiver (IR)

402 explosion

404 rapid pan of high detail

502 discrete cosine transform unit

504 quantizer

506 variable length encoder

512 motion compensation unit

516 dequantizer

518 inverse discrete cosine transform unit

522 variable length decoder

524 dequantizer

526 inverse discrete cosine transform unit

528 motion compensation unit

601-608 digital video compressing and restructuring devices (or called Q-mux)

611-613 video compressors

621 trancoder

622 input buffer

623 output buffer

624 disc drives (computer disc drives)

625 high speed network

631 multiplexer

640 Ethernet network switch (etherswitch)

650 8:1 multiplexe

700 trancoder

702 decoder

704 encoder

712 delay buffer

714 quantization scale predictor

716 variable length decoder

718 dequantizer

720 quantizer

722 variable length encoder

802 input layer

804 concealed layer

806 output layer

901-908 digital video compressing and restructuring devices

910 multiplexer

912 modulator

914 frequency multiplier (frequency raiser)

916 cable

918 set-top-box

920 TV set

930 digital video compressing and restructuring device

931 video tape

932 compact disc (CD)

933 digital video disc (DVD)

934 disc (hard or floppy)

935 cable system

936 satellite antenna

937 satellite

938-939 satellite antenna

940 head-end

B1.B2 bit stream (digital video data stream)

### DETAILED DESCRIPTION OF THE PREFERRED EMBODIMENTS

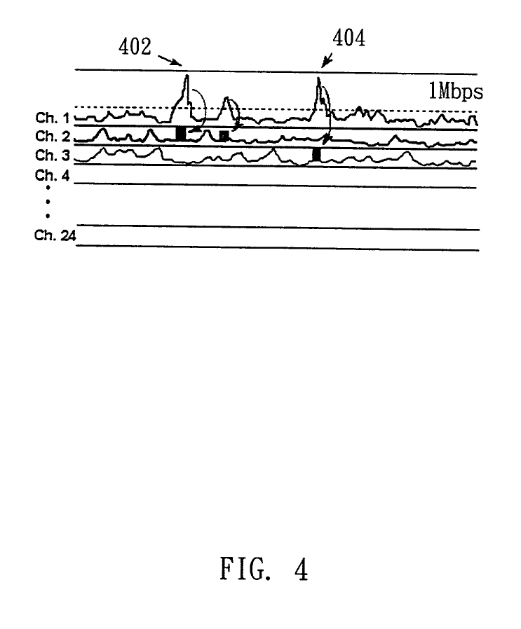

According to the present invention, digital video contents are directly compressed and multiple video programs are merged into a single video channel. It can be seen from FIG. 4 that most of video bandwidth ranges below 1 Mbps therefore further exploitation of bandwidth can be achieved by further compressing digital video signals (digital video data stream).

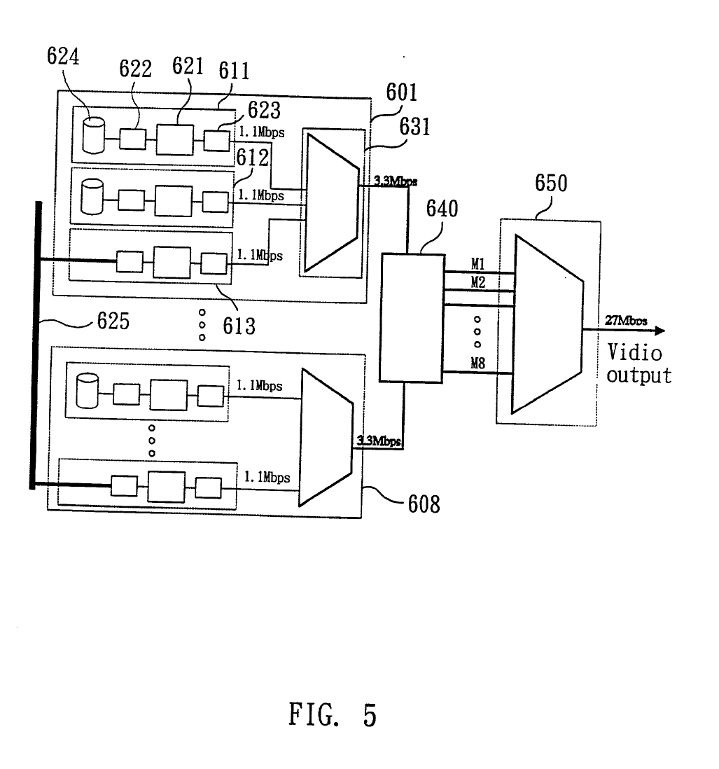

FIG. 5 shows an embodiment of the present invention, which comprises 8 digital video compressing and restructuring devices 601-608 each including 3 video compressors, such as 3 video compressors 611-613 included in 601, each of video compressors 611-613 has a trancoder 621 and buffers connected to its input and output. For example, video compressor 611 includes trancoder 621 for converting video codes of 3.3 Mbps or higher transmission speed into video codes of 1.1 Mbps. Trancoder 621 has its input and output respectively connected to input buffer 622 and output buffer 623 each with a memory capacity of 1 Mb for temporarily saving video signals. The digital video signals (digital video data stream) retrieved from disc drives 624 are compressed by trancoder 621 to become video codes of 1.1 Mbps. The video compressor may also receive digital video signals (digital video data stream) from another kinds of sources such as that video compressor 613 receives digital video signals (digital video data stream) from high speed network 625 and compresses the received digital video signals (digital video data stream).

3 video compressor 611-613 output signals to be integrated by multiplexer 631 to form signals of 3.3 Mbps. 8 digital video compressing and restructuring devices 601-608 output signals to be sent to 8:1 multiplexe 650 through etherswitch 640, and then integrated step by step to form digital video signals (digital video data stream) of 27 Mbps to be outputted.

Each video compressor in the embodiment compresses video signals into video codes of 1.1 Mbps, each of digital video compressing and restructuring devices 601-608 has 3 video compressors and has output of 3.3 Mbps, outputs of 8 digital video compressing and restructuring devices 601-608 fit right in a channel of 27 Mbps, thereby a single channel can accommodate up to (3×8=)24 video programs which are 3 times what a conventional system can provide, allowing cable TV companies to have optimum arrangement in facing clients and video program providers, in order to maximize the number of programs while minimize the number of channels.

It shall be known by those who are skilled in the art that the video compressor and the video compressing and restructuring device suggested by the present invention are not limited by the aforementioned embodiments. Their configuration or design, as well as constituent number can be modified to adapt to system requirements, which are not beyond the scope of the present invention.

A preferred embodiment of the hardware for the present invention is that a digital video compressing and restructuring device comprises a mother board and 3 pieces of Single Board Personal Computer (SBPC); the mother board comprises Central Processing Unit (CPU), Read Only Memory, (ROM), Random Access Memory (RAM), disc drives, and high speed network interface; each SBPC comprises CPU. ROM, RAM; 8:1 multiplexe 650 can be made of a CPU (or a computer).

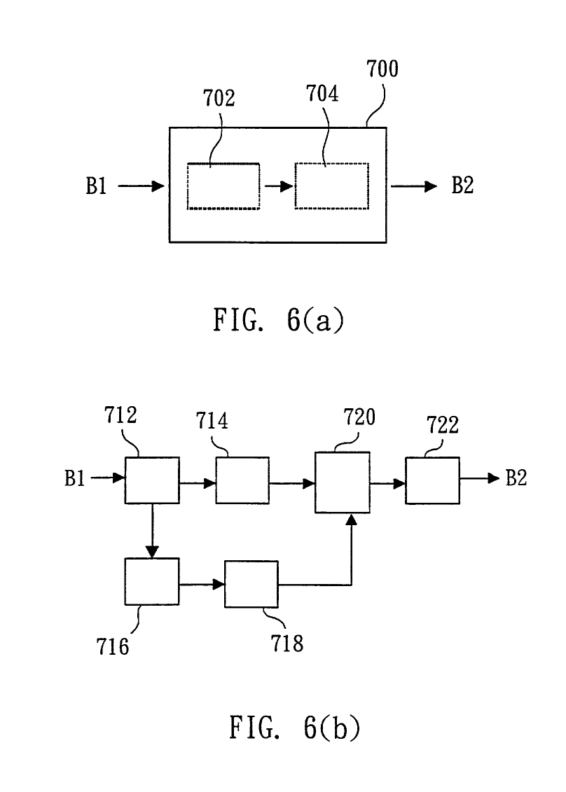

A preferred embodiment of the trancoder is shown in FIG. 6(a) and FIG. 6(b). FIG. 6(a) briefly illustrates trancoder 700 comprising decoder 702 for decoding inputted bit stream (digital video data stream) B1 and encoder 704 for receiving the bit stream (digital video data stream) decoded by decoder 702 and encoding it into bit stream (digital video data stream) B2. Detailed description of trancoder 700 is shown in FIG. 6(b) where delay buffer 712 adjusts inputted bit stream (digital video data stream) B1 and generates an overflow signal according to its overflow status; quantization scale predictor 714 estimates, based on nonlinear algorithm, optimum quantization scale according to the current overflow status and the video signal segment to be outputted immediately; variable length decoder 716 restores the signal produced by a variable length encoder to numeral codes; dequantizer 718 restores quantized signal; quantizer 720 proceeds another quantization according to the outputs of quantization scale predictor 714 and dequantizer 718; its output is processed by variable length encoder 722 to provide bit stream (digital video data stream) B2 as an output.

The trancoder is characterized in that the parts of video signal which are to be well sensed by human eyes are less compressed while those which are to be less sensed by human eyes are more compressed, in order to achieve maximum compression while maintain frame quality in the range human eyes can tolerate.

The compression can be easily done by software in a personal computer for meeting most requirements for video display quality. The algorithm for compressing data in the present invention is to determine a new quantization scale when quantizing data, i.e., relatively rough quatitization scale is given to the complicated parts (the parts with roughness not easily sensed by human eyes) of a frame, while relatively fine quantization scale is given to the plain parts (the parts with roughness easily sensed by human eyes) of a frame.

In the operation of MPEG2 compression, image processing is done on the basis of basic unit (Macroblock; MB) which comprises 8×8 Pixels. The image signal contained in a MB is processed by a discrete cosine transformation to become a transformation coefficient Cᵢⱼ; quantization is one of several main steps in the MPEG compression of video signals. If transformation coefficient Cᵢⱼ is divided by quantization step size, and then an operation of making integers is applied, quantization levels Lᵢⱼ are obtained below

$${L}_{i , j} = int [ \frac{α \cdot {C}_{i , j}}{{q}_{s} {ω}_{i , j}} ] , i , j = 1 , … , 8 \qquad \text{(equation 2)}$$

where qₛ is quantization scale, and is an integer ranging from 1 to 31 in MPEG2; ωᵢⱼ is a quantization matrix for applying different weighting of processing to the transformation of different locations, the weighting is established through observation by human eyes; practically, however, the higher frequency the transformation coefficient is associated with, the less sensitivity it has to human eyes, and the corresponding locations in the matrix have bigger coefficient (less fine), while the locations corresponding to a transformation coefficient associated with lower frequency have smaller matrix value which leads to finer quantization step size, here a is a quantization constant, and is assigned to equal 2⁴.

Each video frame having a necessity of bit rate trancoding shall have its frame type remain unchanged, and have the number of its total bits and each average quantization scale as well as the number of corresponding bits recorded. Take I Frame for example, assume the number of bits of a temporarily recorded frame is B^{Prev} bits, the bit rate of inputted video signals is R₁ Mbps, and the bit rate of outputted video signals is R₂ Mbps, the desired number of bits (T bits) of trancoded output for the frame is obtained according to the ratio between the bit rates as follows,

$$T = \frac{{R}_{2}}{{R}_{1}} \cdot {B}^{prev} \qquad \text{(equation 3)}$$

the number T is the desired number of bits set before the frame is trancoded, and is theoretically an ideal number of bits of the trancoded output for the frame. The object of controlling bit rate is to make the number of bits of the trancoded output for the frame approximate the desired number of bits.

After calculating the desired number of bits fir a frame, the Complexity estimation Cⱼ of each MB of the frame is then computed, and the desired number of bits (T^{mb}bits) of each MB is allocated according to the Complexity estimation Cⱼ of the MB, as shown below,

$${T}_{j}^{mb} = \frac{{C}_{j}}{{C}_{1} + {C}_{2} + … + {C}_{m}} T , 1 ≦ j ≦ m \qquad \text{(equation 4)}$$

$${C}_{j}^{1} = {q}_{j} ? {B}^{prev} , j = 1 , … , m \qquad \text{(equation 5)}$$

where nm is the number of all MBs in the frame, T is the desired number of all bits in the frame. Computation of Cⁱⱼ is shown by equation 5 where qⱼ is the quantization scale of the j th MB of an inputted frame, B^{prev}ⱼ is the number of the bits which are in the inputted frame and are enclosed by the MB. Because the input to the trancoder is MPEG2 video signals, the encoded data for inputted video signals can be known when proceeding trancoding, and higher efficiency and accuracy can be thus achieved by setting desired number of bits according to the Complexity estimation Cⱼ of each MB.

Whenever the trancoding for a MB is completed during the process of trancoding, the overflow coefficient of virtual buffer shall be updated as shown by equation 6 below,

dⁱⱼ=dⁱ₀+B^{mb}ⱼ₋₁−T^{mb}ⱼ₋₁ (equation 6)

where dⁱⱼ is the overflow coefficient of virtual buffer when trancoding the j th row, B^{mb}ⱼ₋₁ is the number of bits of the output for the (j-1) th row, Tⱼ₋1^{mb} is the desired number of bits computed by equation 4 for the (j-1) th row.

It can be seen from equation 6 that dⁱⱼ is successively accumulated. In case the number (B^{mb}) of bits of the trancoded output for each row before the (j-1) th row exceeds the computed desired number T^{mb}, dⱼⁱ will gradually become bigger until Quantization scale gets so big that the number of outputted bits starts to be smaller than desired number of bits. This is the time the overflow coefficient begins to fall off.

In equation 6, dⁱ₀ is the initial value of overflow coefficient for I frame, the initial value in the beginning is

$${d}_{0}^{i} = {q}_{seed} \cdot \frac{γ}{31} \qquad \text{(equation 7)}$$

where γ is the value obtained through dividing bit rate by the number of frames per second, i.e.,

$$γ = 2 \cdot \frac{bit\_rate}{frame\_rate} \qquad \text{(equation 8)}$$

$${q}_{seed} = {q}_{1} \cdot exp [ \frac{{R}_{1} - {R}_{2}}{β} ] \qquad \text{(equation 9)}$$

where q1 is the quantization scale of the first MB of the first frame, β is a coefficient related to q1 and is used as the initial value of the overflow coefficient for next I frame. For P frame and B frame, the steps before computing overflow coefficient are the same as those for I frame.

For each MB, the quantization scale predictor suggested by the present invention can be used to obtain in advance the qᵢ^{opt} (Optimal Quantization scale) given that the current overflow coefficient dᵢ₋₁ and its desired number T^{mb}ᵢ of bits are known. The predication based on dᵢ₋₁ and Tᵢ^{mb}, is usually not good enough, because the predication for best qᵢ^{opt} based on current dᵢ₋₁ and T₁^{mb} may heavily affect the qᵢ₊₁^{opt} for next MB, such as the case Tᵢ₊₁^{mb} becomes verse large while d_{I} is not big enough, resulting in a poor scale to quantize Tᵢ^{mb} for qᵢ₊₁^{opt} . Observation of more Tⱼ^{mb}(j>1) will be more proper for determining relatively suitable qᵢ^{opt}. It must also be noted that the relations between qᵢ^{opt} and dᵢ₋₁, Tᵢ^{mb} , Tᵢ₊₁^{mb}, . . . are nonlinear, and therefore the computation for the predication can be based only on experienced formula associated with complicated computation and accompanied with inaccuracy It is therefore an object of the present invention to provide a neural network workable with learning approach in order to better define the relations between qᵢ^{opt} and dᵢ₋₁, Tᵢ^{mb}, T_{I+1}^{mb}, . . . ,.

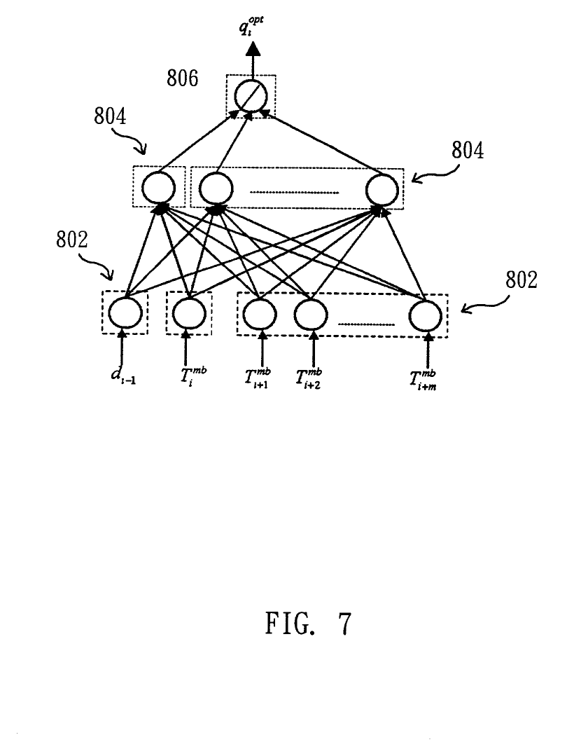

FIG. 7 shows a preferred embodiment of a neural network which is a 3 layer of Multi-Layer Perceptron (MLP). It comprises an input layer 802, a concealed layer 804, and an output layer 806. Try each of various different values for dᵢ₋₁, T^{mb}ᵢ₋₁, . . . , to find, by human experimentation, a qᵢ^{opt} for best frame performance, and then train the neural network according to these values. Due to its Generalization capability, the neural network can make optimum predication for various cases. It must be noted that the output value of the neural network ranges between 0 and 1, thereby the outputted qᵢ^{opt} appears as a normalized value which must be multiplied by a constant.

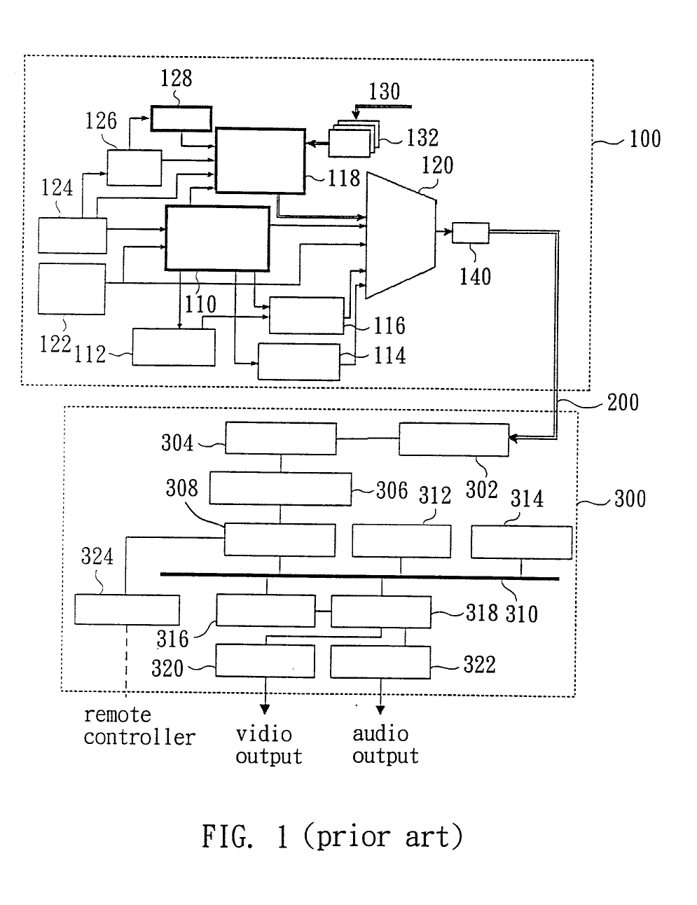

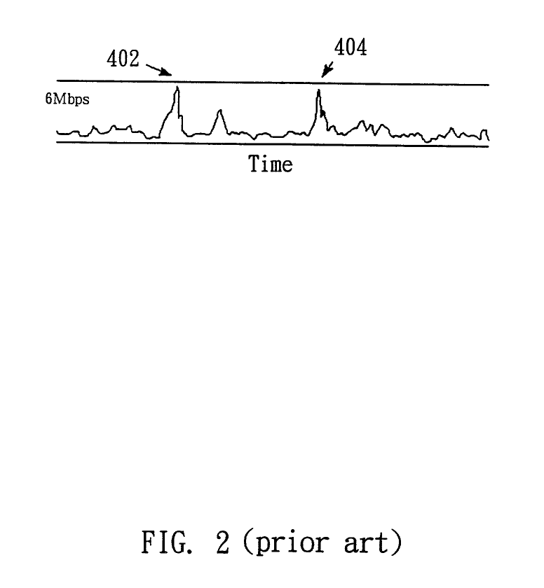

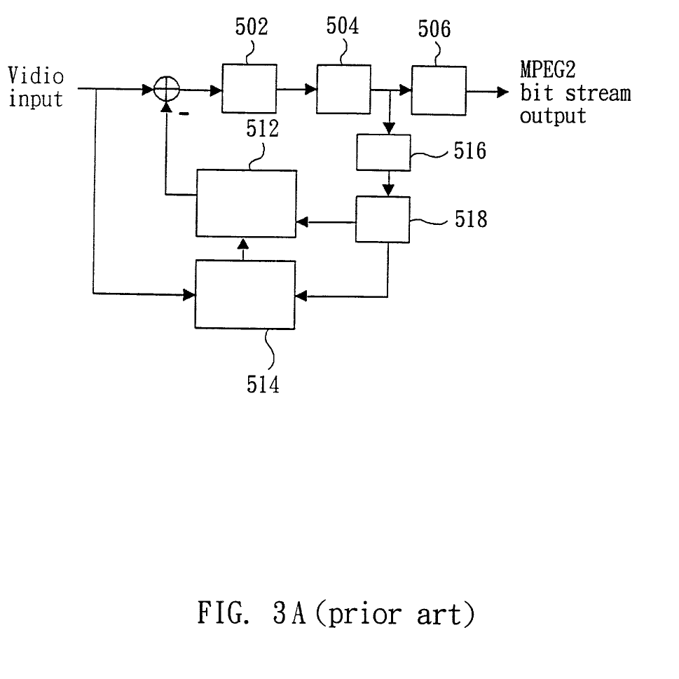

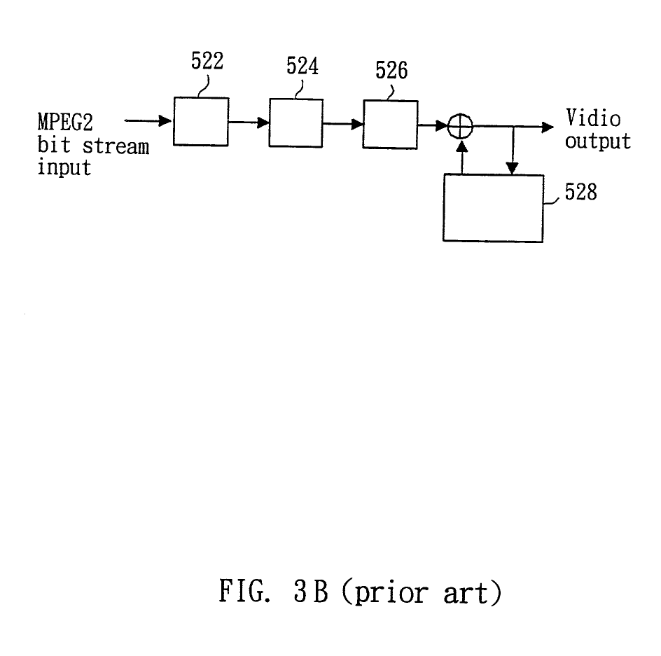

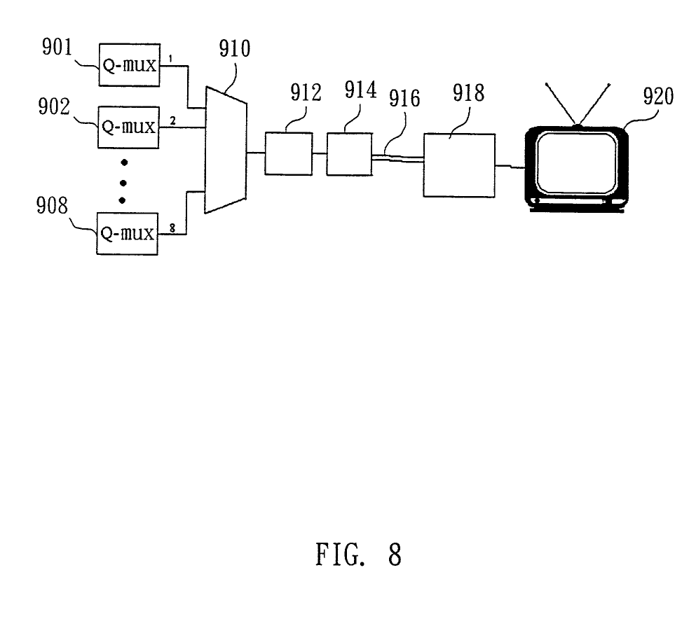

FIG. 8 shows an application example of the cable TV broadcasting and receiving system suggested by the present invention. Configured on broadcasting site are 8 digital video compressing and restructuring devices 901-908 forming a single channel through multiplexer 910, with video output fed to cable 916 through modulator 912 and frequency multiplier 914, for users to retrieve video programs from set-top-box 918 on remote site and display the programs on TV set 920. The operation of set-top-box 918 is the same as the set-top-box 300 shown in FIG. 1.

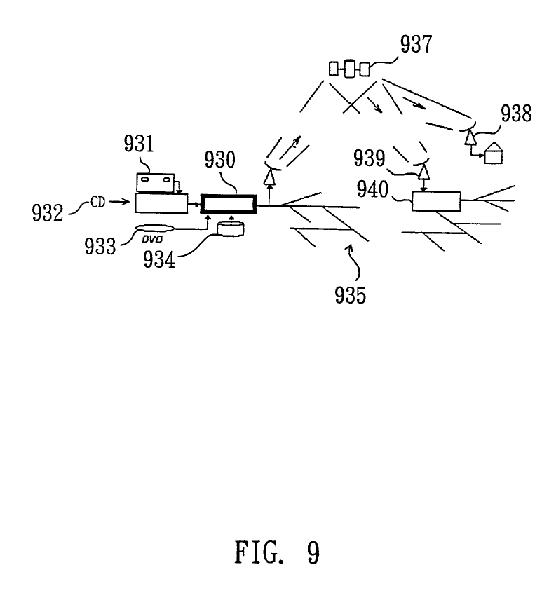

The present invention' feature of enabling a single channel to accommodate many programs contributes significantly to the establishment of a Video On Demand (VOD) system. FIG. 9 shows an analogy Video On Demand system (NVOD) provided by the present invention, in which a digital video compressing and restructuring device 930 as that shown in FIG. 5 is configured on broadcasting site, and 24 video programs are merged into a single channel. There can be various options for the source of the video programs, among which are video tape 931, Compact Disc (CD) 932, compressed video signals, digital video disc (DVD) 933, and floppy disc 934 containing compressed image, etc. After being integrated by digital video compressing and restructuring device 930, and broadcast through cable system 935 or through satellite antenna 936 as well as uplink satellite 937, these programs can be directly received by users through satellite antenna 938, or received by cable TV service companies through satellite antenna 939 and then fed to cable system 935 via headend 940. Because 24 programs can be merged in a channel, if a hot program is broadcast through a sub-channel every 2.5 minutes, by considering 2.5 minutes×24=60 minutes (equation 10), it can be seen that the broadcasting of a movie based on a NVOD provided by the present invention can proceed with original video signals of one copy.

While the invention is described in terms of what are presently considered to be the most practical and preferred embodiments, it must be understood that the invention is not limited to the disclosed embodiment. On the contrary, it is to cover various modifications and similar arrangements included within the spirit and scope of the following claims which are to be accorded with the broadest interpretation to encompass all modifications and similar structures based thereon.

What is claimed is:

1. A method for compressing and restructuring video signals to promote the usefulness of a video channel, comprising the steps of:
(a) processing a plurality of digital video data streams to form digital video data streams each having a desired bandwidth; and
(b) integrating the digital video data streams having said desired bandwidth into an integrated digital video data stream having a bandwidth fitting said video channel.

2. The method according to claim 1 wherein step (a) comprises the steps of: compressing each of said plurality of digital video data streams into a digital video data stream having a certain bandwidth; inputting the digital video data streams having said certain bandwidth to multiplexers for forming digital video data streams having said desired bandwidth.

3. The method according to claim 1 wherein in step (b) a multiplexer is used to integrate the digital video data streams having said desired bandwidth.

4. The method according to claim 1 wherein said digital video data stream is the video data having been compressed by MPEG2.

5. The method according to claim 1 wherein the bandwidth of said video channel is the bandwidth of an analog TV video channel of 6 MHz.

6. A device for compressing and restructuring video signals to promote the usefulness of a video channel, comprising:
a plurality of video compressors each compressing a digital video data stream applied thereto into a digital video data stream having a certain bandwidth.
a multiplexer receiving the digital video data streams having said certain bandwidth to provide a digital video data stream having a desired bandwidth.

7. The method according to claim 6 wherein said video compressor comprises a trancoder for compressing the bit rate of the digital video data stream applied thereto.

8. A video compressor for compressing digital video data stream, comprising:
a trancoder for compressing the bit rate of said digital video data stream;
an input buffer and an output buffer respectively connected to the input pin and output pin of said trancoder, for temporarily saving the video code of said digital video data stream.

9. The video compressor according to claim 8 wherein said trancoder comprises:
a delay buffer receiving from the output pin of said trancoder said digital video data stream which is then adjusted therein, and generating an overflow signal according to the overflow status thereof;
a variable length decoder for decoding the video codes of said digital video data stream to obtain numeral codes;
a dequantizer for restoring quantized data;
a quantization scale predictor nonlinearly computing, according to said overflow signal and the amount of said digital video data stream to be outputted immediately, to provide an quantization scale;
a quantizer proceeding quantization to provide an output according to the quantization scale provided by said quantization scale predictor and the quantized data restored by said dequantizer;
a variable length encoder for encoding the output provided by said quantizer.

10. The video compressor according to claim 9 wherein said quantization scale predictor is made of a neural network, and inputs said overflow signal, the number of bits of current Macroblock as well as the Macroblocks following thereafter.

11. The video compressor according to claim 9 wherein said quantization scale predictor provides a signal to indicate a normalized value of said quantization scale, said normalized value is multiplied by a constant for obtaining a quantization scale to be provided to said trancoder.

12. The video compressor according to claim 10 wherein said quantization scale predictor provides a signal to indicate a normalized value of said quantization scale, said normalized value is multiplied by a constant for obtaining a quantization scale to be provided to said trancoder.
